(19) United States
(12) Patent Application Publication
(10) Pub. No.: US 2016/0362143 A1
(43) Pub. Date: Dec. 15, 2016

(54) SPLASH GUARD ASSEMBLY AND PRODUCT

(71) Applicant: GM GLOBAL TECHNOLOGY OPERATIONS LLC, Detroit, MI (US)

(72) Inventors: Michael F. Erickson, Warren, MI (US); Vinay K. Saini, Wiindsor (CA); Bill Iordanou, Linden, MI (US); Michael J. Briskey, Roseville, MI (US)

(73) Assignee: GM GLOBAL TECHNOLOGY OPERATIONS LLC, Detroit, MI (US)

(21) Appl. No.: 14/737,953

(22) Filed: Jun. 12, 2015

(51) Int. Cl. B62D 25/16

(52) U.S. Cl. CPC B62D 25/163

(57) ABSTRACT

A splash guard assembly for a product includes an inner component abuttable with the product and defining a first hole, an outer component abuttable with the inner component and the product and defining a second hole, and a first fastener. The first fastener is insertable into the first hole and the second hole so that the inner component is attached to the outer component and the product is sandwiched between the inner component and the outer component. A product includes a fender defining a cavity and the splash guard assembly attached to the fender within the cavity.

### TECHNICAL FIELD

The disclosure relates to a splash guard assembly.

### BACKGROUND

Products, such as vehicles, personal protective equipment, holding containers, and gutters are often used in wet and/or dirty environments. For example, vehicles such as automobiles, motorcycles, recreational vehicles, boats, railcars, and earth movers often operate in rain, snow, and/or mud. As a wheel of the vehicle travels along a surface, moisture and contaminants may be sprayed onto an external surface of the vehicle. Similarly, helmets, basins, and gutters often require water or debris to be contained and/or diverted.

### SUMMARY

A splash guard assembly for a product includes an inner component abuttable with the product and defining a first hole. The splash guard assembly also includes an outer component abuttable with the inner component and the product and defining a second hole. The splash guard assembly further includes a first fastener insertable into the first hole and the second hole so that the inner component is attached to the outer component and the product is sandwiched between the inner component and the outer component.

In one embodiment, the inner component has a first panel and a second panel extending from the first panel so that the inner component has an L-shaped cross-section. In addition, the outer component has a first leg and a second leg extending from the first leg, and the first fastener does not extend through the product.

A product includes a fender defining a cavity and the splash guard assembly attached to the fender within the cavity. The splash guard assembly includes the inner component abutting the fending and defining the first hole, the outer component abutting the inner component and the fender and defining a second hole, and the first fastener inserted into the first hole and the second hole so that the inner component is attached to the outer component and the fender is sandwiched between the inner component and the outer component.

The above features and advantages and other features and advantages of the present disclosure will be readily apparent from the following detailed description of the preferred embodiments and best modes for carrying out the present disclosure when taken in connection with the accompanying drawings and appended claims.

### BRIEF DESCRIPTION OF THE DRAWINGS

FIG. 1 is a schematic illustration of a perspective, partial view of a product;

FIG. 2 is a schematic illustration of a perspective view of a splash guard assembly for the product of FIG. 1 as shown during assembly;

FIG. 3 is a schematic illustration of a cross-sectional, partial view of the splash guard assembly of FIG. 2 taken along section lines 3-3;

FIG. 4 is a schematic illustration of a cross-sectional, partial view of the splash guard assembly of FIG. 2 taken along section lines 4-4; and

FIG. 5 is a schematic illustration of a cross-sectional, partial view of the splash guard assembly of FIG. 2 taken along section lines 5-5.

### DETAILED DESCRIPTION

Referring to the Figures, wherein like reference numerals refer to like elements, a splash guard assembly 10 for a product 12 is shown. The splash guard assembly 10 may be suitable for products 12 that operate in wet and/or dirty conditions such as, but not limited to, vehicles, e.g., automotive vehicles, construction equipment, and railcars; personal protective equipment, e.g., helmets and eyewear; holding containers, e.g., tubs and basins; and troughs such as gutters. For example, in one non-limiting embodiment, the product 12 may be a passenger sedan, a pick-up truck, a sport utility vehicle, and the like. The splash guard assembly 10 may protect the product 12 from splashed or sprayed liquids or solids during operation of the product 12 and may also be referenced as a splash apron assembly or a mud flap assembly. The splash guard assembly 10 may attach to the product 12 without compromising a structure or integrity of the product 12. That is, the splash guard assembly 10 may attach to the product 12 regardless of whether the product 12 defines existing attachment holes. That is, the splash guard assembly 10 may be attached to the product 12 without forming, e.g., drilling or piercing, attachment holes in or through the product 12, as set forth in more detail below.

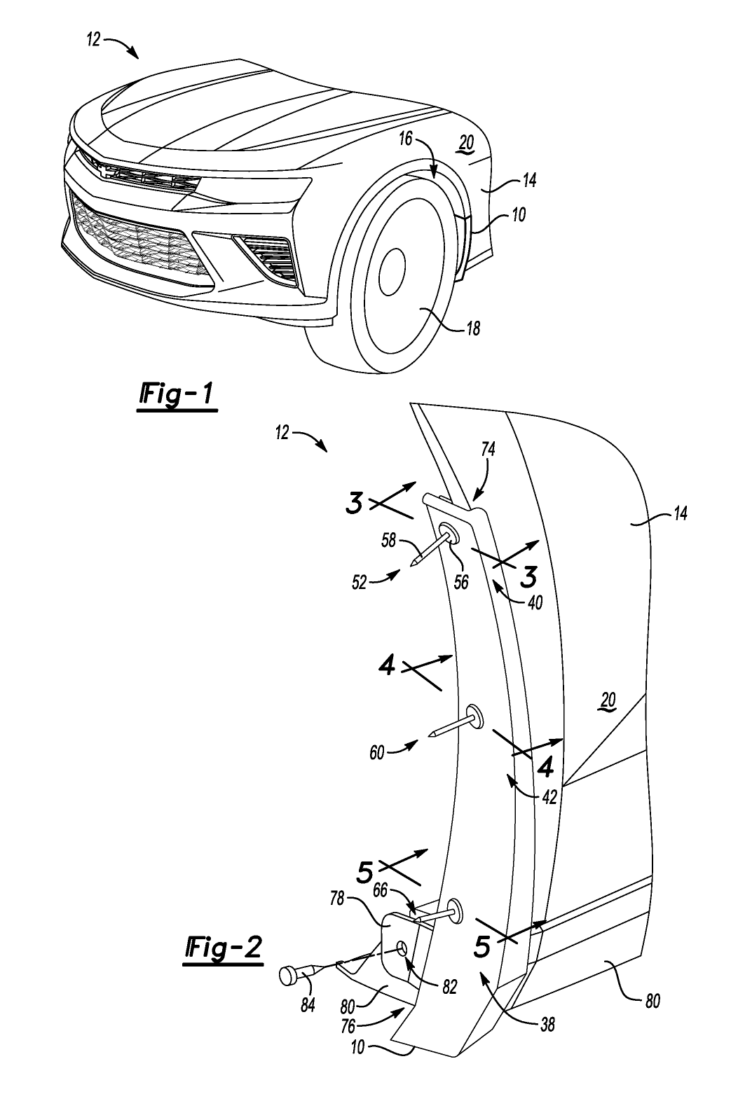

As best shown in FIG. 1, the product 12 may include a fender 14 defining a cavity 16. In the case of automotive vehicles, the cavity 16 may be a wheel well configured for surrounding a wheel 18 (FIG. 1) of the vehicle. The fender 14 may be a front or rear fender 14 of the product 12. For non-automotive products 12, the fender 14 may be any flange suitable for supporting the splash guard assembly 10. For example, the fender 14 may be a brim of a helmet, an edge of a gutter, a panel of a basin, and the like. As a non-limiting example, the fender 14 may be formed from a metal, such as steel or aluminum.

Referring again to FIG. 2, the splash guard assembly 10 is attachable to the fender 14 within the cavity 16. That is, at least part of the splash guard assembly 10 may be disposed within the cavity 16. Importantly, however, the splash guard assembly 10 is attachable to the fender 14 without compromising the integrity and/or structure of the fender 14. That is, attachment of the splash guard assembly 10 does not require the product 12 to define existing attachment holes and does not require drilling or piercing the product 12 to define attachment holes. Since drilling attachment holes into the product 12 may not be an accurately-reproducible process and/or may initiate or contribute to corrosion of the product 12, the splash guard assembly 10 may be suitable for products 12 requiring repeatable and robust attachment and removal of the splash guard assembly 10. When attached to the fender 14, the splash guard assembly 10 may protect the fender 14 and an exterior surface 20 (FIG. 1) of the product 12 from splashed or sprayed moisture and/or debris. That is, the splash guard assembly 10 may defray and minimize the spray or splash of water, mud, snow, and/or stones along the exterior surface 20 during operation of the product 12 in wet and/or dirty conditions.

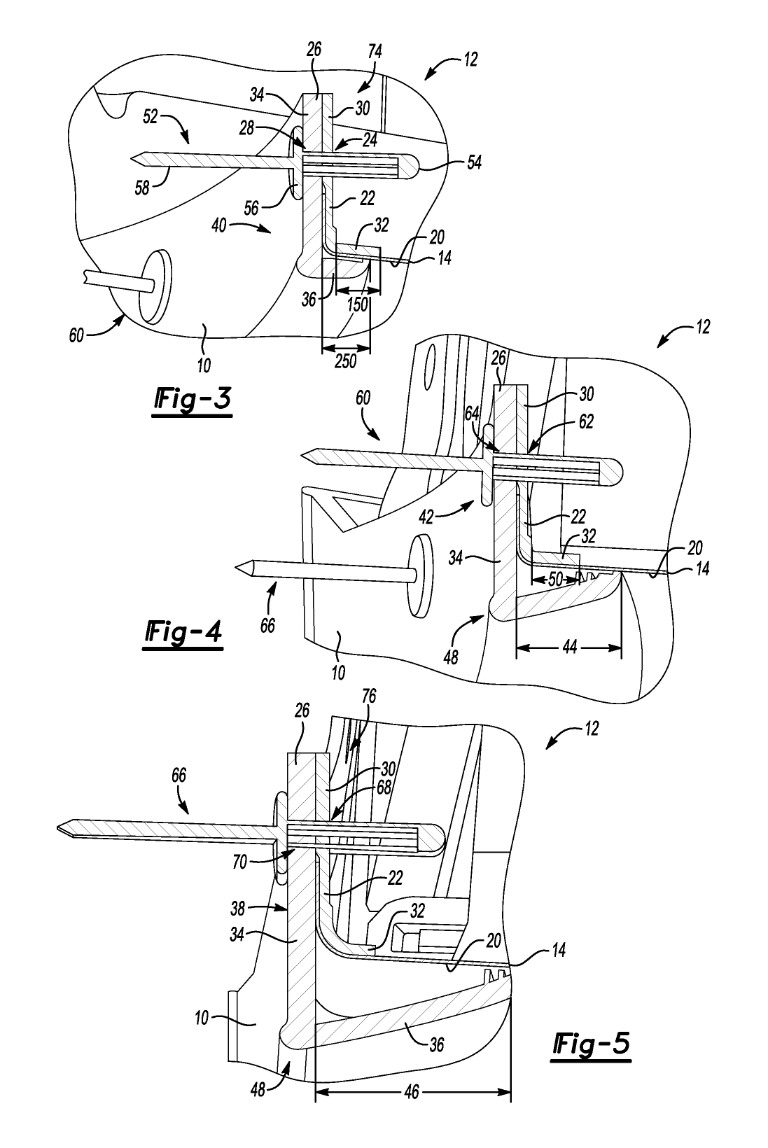

Referring now to FIG. 3, the splash guard assembly 10 includes an inner component 22 abuttable with the product 12 and defining a first hole 24. That is, the inner component 22 may define the first hole 24 through the inner component 22. The splash guard assembly 10 also includes an outer component 26 abuttable with the inner component 22 and the product 12 and defining a second hole 28. That is, the outer component 26 may define the second hole 28 through the outer component 26.

More specifically, as best shown in FIGS. 3-5, the inner component 22 may have a first panel 30 and a second panel 32 extending from the first panel 30 so that the inner component 22 has an L-shaped cross-section. As used herein, the terminology cross-section refers to a shape that would be exposed by slicing through the object with a plane. The first panel 30 may define the first hole 24 and abut the product 12, and the second panel 32 may not define the first hole 24 but may also abut or contact the product 12.

As also shown in FIGS. 3-5, the outer component 26 may have a first leg 34 and a second leg 36 extending from the first leg 34. Further, as best shown in FIG. 1, the outer component 26 may have a distal portion 38 abuttable with the product 12, a proximal portion 40 spaced apart from the distal portion 38 and abuttable with the product 12, and a middle portion 42 disposed between the distal portion 38 and the proximal portion 40 and abuttable with the product 12.

Referring now to FIG. 3, the outer component 26 may also have an L-shaped cross-section along the proximal portion 40. However, referring to FIGS. 4 and 5, the outer component 26 may have a V-shaped cross-section along the middle portion 42 and the distal portion 30. In particular, as shown in FIG. 4, the second leg 36 may extend from the first leg 34 to a first distance 44 along the middle portion 42. However, referring to FIG. 5, the second leg 36 may extend from the first leg 34 to a second distance 46 that is greater than the first distance 44 along the distal portion 38. That is, as best shown by comparing FIGS. 4 and 5, as the outer component 26 contours from the proximal portion 40 to the distal portion 38, an apex 48 of the V-shaped cross-section may gradually extend farther from the fender 14 as the first leg 34 increases in width.

In addition, as described with reference to FIG. 4, the second panel 32 of the inner component 22 may extend from the first panel 30 to a third distance 50 that is less than the first distance 44 and less than the second distance 46. However, at the proximal portion 40 (FIG. 3), the second panel 32 may extend from the first panel 30 to a fourth distance 150, and the second leg 36 may extend from the first leg 34 at a fifth distance 250 that is greater than the fourth distance 150. Therefore, the outer component 26 may curve or slope from the proximal portion 40 to the distal portion 38 and may match a slope or shape of the fender 14. As a non-limiting example, the inner component 22 and the outer component 26 may be formed from a plastic, such as a thermoplastic or an elastomer.

Referring again to FIGS. 2 and 3, the splash guard assembly 10 further includes a first fastener 52 insertable into the first hole 24 (FIG. 3) and the second hole 28 (FIG. 3) so that the inner component 22 is attached to the outer component 26 and the product 12 is sandwiched between the inner component 22 and the outer component 26. That is, as best shown in FIG. 3, when assembled, the first hole 24 and the second hole 28 may align so that the first fastener 52 is disposed in the first hole 24 and the second hole 28 such that the first fastener 52 may attach the inner component 22 to the outer component 26. The first fastener 52 may be spaced apart from the product 12 so that the first fastener 52 does not pierce or extend through the product 12, e.g., the fender 14. Further, the first fastener 52 may not contact the product 12. Therefore, the splash guard assembly 10 may not contribute to corrosion of the fender 14 since the fender 14 is not drilled or pierced in order to attach the splash guard assembly 10 to the fender 14. Rather, when assembled, the splash guard assembly 10 may grip the product 12, e.g., the fender 14, between the inner component 22 and the outer component 26.

The first fastener 52 may be formed from any suitable material, such as, but not limited to, a plastic, metal, or composite. Further, as described with reference to FIG. 3, the first fastener 52 may include an internal portion 54 extendable through the outer component 26 and the inner component 22, a stop portion 56 abuttable with the outer component 26, and a removable portion 58 extending from the stop portion 56. The removable portion 58 may be sheared off after insertion of the first fastener 52 into the first hole 24 and the second hole 28, i.e., after assembly of the splash guard assembly 10 or attachment of the splash guard assembly 10 to the product 12. As non-limiting examples, the first fastener 52 may be configured as a plastic rivet or clip.

Referring again to FIG. 2, the splash guard assembly 10 may also include a second fastener 60. Further, the inner component 22 may define a third hole 62 (FIG. 4) spaced apart from the first hole 24 (FIG. 3), and the outer component 26 may define a fourth hole 64 (FIG. 4) spaced apart from the second hole 28 (FIG. 3). That is, the second hole 28 may be defined at the proximal portion 40 and the fourth hole 64 may be defined at the middle portion 42 of the outer component 26. As shown in FIG. 4, the second fastener 60 may be insertable into the third hole 62 and the fourth hole 64.

The second fastener 60 may be disposed in or inserted into the third hole 62 and the fourth hole 64 and may not contact the product 12. That is, the second fastener 60 may be spaced apart from the product 12 so that the second fastener 60 also does not pierce or extend through the product 12, e.g., the fender 14. The second fastener 60 may be formed from the same material or a different material as the first fastener 52, and the second fastener 60 may have the same shape or structure or a different shape or structure than the first fastener 52. As non-limiting examples, the second fastener 60 may also be configured as a plastic rivet or clip.

Referring again to FIG. 2, the splash guard assembly 10 may also include a third fastener 66. Further, the inner component 22 may define a fifth hole 68 (FIG. 5) spaced apart from the third hole 62 (FIG. 4), and the outer component 26 may define a sixth hole 70 (FIG. 5) spaced apart from the fourth hole 64 (FIG. 4). That is, the sixth hole 70 may be defined at the distal portion 38 of the outer component 26. As shown in FIG. 2, the third fastener 66 may be insertable into the fifth hole 68 and the sixth hole 70.

The third fastener 66 may be disposed in or inserted into the fifth hole 68 and the sixth hole 70 and may not contact the product 12. That is, the third fastener 66 may be spaced apart from the product 12 so that the third fastener 66 also does not pierce or extend through the product 12, e.g., the fender 14. The third fastener 66 may be formed from the same material or a different material as the first fastener 52 and/or the second fastener 60, and the third fastener 66 may have the same shape or structure or a different shape or structure than the first fastener 52 and/or the second fastener 60. In one non-limiting embodiment, the third fastener 66 may likewise be configured as a plastic rivet or clip.

Referring again to FIG. 2, the inner component 22 may have a first end 74 and a second end 76 spaced apart from the first end 74. The inner component 22 may have a shape that is similar to the shape of the outer component 26 and may contour along the fender 14. The inner component 22 may also include a flange 78 disposed at and extending from the second end 76. The flange 78 may be configured for attaching to the product 12. For example, the product 12 may include a molding 80 attached to the fender 14. That is, the molding 80 may be a rocker molding or trim piece, and the flange 78 may be attachable to the molding 80. The flange 78 may define a seventh hole 82, and the splash guard assembly 10 may further include a fourth fastener 84 insertable into the seventh hole 82. The fourth fastener 84 and the flange 78 may provide the splash guard assembly 10 with secure attachment to the product 12.

Therefore, the splash guard assembly 10 may be especially suitable for attachment to products 12 which operate in wet and/or dirty environments. Since the splash guard assembly 10 includes the inner component 22 and the outer component 26, the splash guard assembly 10 may attach to products 12 which do not define existing attachment holes and without drilling attachment holes into the product 12. Rather, the inner component 22 and the outer component 26 may clamp or sandwich the product 12 so that potentially-corrosion-inducing attachment holes in the product 12 are not required for attachment. Further, since some products 12 may be too narrow to accept a drill bit or a punch, the splash guard assembly 10 may be suitable for attaching to products 12 having tight clearances between components. Further, the splash guard assembly 10 may be easily installed and removed from the product 12 and does not require specialized knowledge of sheet metalworking techniques.

While the best modes for carrying out the disclosure have been described in detail, those familiar with the art to which this disclosure relates will recognize various alternative designs and embodiments for practicing the disclosure within the scope of the appended claims.

1. A splash guard assembly for a product, the splash guard assembly comprising:
an inner component abuttable with the product and defining a first hole;
an outer component abuttable with the inner component and the product and defining a second hole; and
a first fastener insertable into the first hole and the second hole so that the inner component is attached to the outer component and the product is sandwiched between the inner component and the outer component.

2. The splash guard assembly of claim 1, wherein the first fastener is disposed in the first hole and the second hole and does not extend through the product.

3. The splash guard assembly of claim 1, wherein the inner component further defines a third hole spaced apart from the first hole, and the outer component further defines a fourth hole spaced apart from the second hole, and further including a second fastener insertable into the third hole and the fourth hole.

4. The splash guard assembly of claim 3, wherein the second fastener is disposed in the third hole and the fourth hole and does not extend through the product.

5. The splash guard assembly of claim 3, wherein the inner component further defines a fifth hole spaced apart from the third hole, and the outer component further defines a sixth hole spaced apart from the fourth hole, and further including a third fastener insertable into the fifth hole and the sixth hole.

6. The splash guard assembly of claim 5, wherein the third fastener is disposed in the fifth hole and the sixth hole and does not extend through the product.

7. A splash guard assembly for a product, the splash guard assembly comprising:
an inner component abuttable with the product and defining a first hole, wherein the inner component has a first panel and a second panel extending from the first panel so that the inner component has an L-shaped cross-section;
an outer component abuttable with the inner component and the product and defining a second hole, wherein the outer component has a first leg and a second leg extending from the first leg; and
a first fastener insertable into the first hole and the second hole so that the inner component is attached to the outer component and the product is sandwiched between the inner component and the outer component;
wherein the first fastener does not extend through the product.

8. The splash guard assembly of claim 7, wherein the outer component has a distal portion abuttable with the product, a proximal portion spaced apart from the distal portion and abuttable with the product, and a middle portion disposed between the distal portion and the proximal portion and abuttable with the product.

9. The splash guard assembly of claim 8, wherein the outer component has an L-shaped cross-section along the proximal portion.

10. The splash guard assembly of claim 8, wherein the outer component has a V-shaped cross-section along the middle portion and the proximal portion.

11. The splash guard assembly of claim 8, wherein the second leg extends from the first leg to a first distance along the middle portion.

12. The splash guard assembly of claim 11, wherein the second leg extends from the first leg to a second distance that is greater than the first distance along the distal portion.

13. The splash guard assembly of claim 11, wherein the second panel extends from the first panel to a third distance that is less than the first distance and less than the second distance.

14. The splash guard assembly of claim 7, wherein the inner component has a first end and a second end spaced apart from the first end, and includes a flange extending from the second end and configured for attaching to the product.

15. The splash guard assembly of claim 14, wherein the flange defines a seventh hole, and further including a fourth fastener insertable into the seventh hole.

16. A product comprising:
a fender defining a cavity; and
a splash guard assembly attached to the fender within the cavity and including:
an inner component abutting the fender and defining a first hole;
an outer component abutting the inner component and the fender and defining a second hole; and
a first fastener inserted into the first hole and the second hole so that the inner component is attached to the outer component and the fender is sandwiched between the inner component and the outer component.

17. The product of claim 16, wherein the first fastener does not extend through the fender.

18. The product of claim 17, wherein the inner component further defines:
a third hole spaced apart from the first hole; and
a fifth hole spaced apart from the third hole;
wherein the outer component further defines:
a fourth hole spaced apart from the second hole; and
a sixth hole spaced apart from the fourth hole; and
further including:
a second fastener inserted into the third hole and the fourth hole; and
a third fastener inserted into the fifth hole and the sixth hole.

19. The product of claim 18, wherein the second fastener does not extend through the fender, and further wherein the third fastener does not extend through the fender.

20. The product of claim 16, further including a molding attached to the fender, wherein the inner component includes a flange that is attached to the molding.
